(19) United States
(12) Patent Application Publication
(10) Pub. No.: US 2026/0319716 A1
(43) Pub. Date: Oct. 15, 2026

(54) NON-TRANSITORY COMPUTER-READABLE RECORDING MEDIUM STORING COMPUTER-READABLE INSTRUCTIONS FOR TERMINAL DEVICE, SERVER, AND COMMUNICATION SYSTEM

(71) Applicant: BROTHER KOGYO KABUSHIKI KAISHA, Nagoya (JP)

(72) Inventor: Yukinori MINAMIYAMA, Nagoya (JP)

(21) Appl. No.: 19/464,118

(22) Filed: Jan. 29, 2026

(30) Foreign Application Priority Data
Jan. 30, 2025 (JP) 2025-013926

(51) Int. Cl. G06F 3/12; H04N 1/34

(52) U.S. Cl. CPC G06F 3/1205; G06F 3/1222; G06F 3/1238; H04N 1/344

(57) ABSTRACT

A non-transitory computer-readable recording medium storing computer-readable instructions for a terminal device, wherein the computer-readable instructions, when executed by a processor of the terminal device, may cause the terminal device to: in a case where a predetermined instruction is inputted, start a setup process for setup of an image processing device; during a period from when the setup process starts until when the setup process ends, collect subscription information including user information and device information; in a case where the setup process ends, display a prompt screen on the terminal device, wherein the prompt screen is for displaying at least the user information of the collected subscription information and prompting to subscribe to the service by using the subscription information and the prompt screen includes a first object; and in a case where the first object included in the prompt screen is selected, execute a subscription process.

### REFERENCE TO RELATED APPLICATIONS

This application claims priority from Japanese Patent Application No. 2025-013926 filed on Jan. 30, 2025. The entire content of the priority application is incorporated herein by reference.

### BACKGROUND ART

A process for subscribing to a flat rate printing service is known. The present teachings provide novel art for subscribing to a service.

### SUMMARY

A non-transitory computer-readable recording medium storing computer-readable instructions for a terminal device is disclosed herein. The computer-readable instructions, when executed by a processor of the terminal device, may cause the terminal device to: in a case where a predetermined instruction is inputted, start a setup process for setup of an image processing device being different from the terminal device; during a period from when the setup process starts until when the setup process ends, collect subscription information for subscribing to a service for the image processing device, wherein the subscription information includes user information related to a user of the image processing device and device information related to the image processing device; in a case where the setup process ends, display a prompt screen on a display unit of the terminal device, wherein the prompt screen is for displaying at least the user information of the collected subscription information and prompting to subscribe to the service by using the subscription information and the prompt screen includes a first object for receiving the user’s approval; and in a case where the first object included in the prompt screen is selected, execute a subscription process for subscribing to the service.

According to the above configuration, the subscription information for subscribing to the service is collected while the setup process is ongoing. The user can subscribe to the service simply by approving subscription to the service in the prompt screen displayed after the end of the setup process. The user can subscribe to the service quickly after the end of the setup process, by which user convenience can be improved.

The above-described terminal device itself and a control method of the above-described terminal device are also novel and useful.

A server is disclosed herein. The server may include: a memory; and a controller configured to: during a period from when a terminal device starts a setup process for setup of an image processing device being different from the terminal device until the terminal device ends the setup process, receive a storing instruction from the terminal device, wherein the terminal device collects subscription information for subscribing to a service for the image processing device during the period from when the terminal device starts the setup process until the terminal device ends the setup process, the subscription information includes user information related to a user of the image processing device and device information related to the image processing device, wherein after the setup process has ended, the terminal device displays a first prompt screen on the terminal device and the first prompt screen is a screen for displaying at least the user information of the collected subscription information and prompting to subscribe to the service by using the subscription information, wherein the storing instruction is an instruction for causing the server to store the device information in the memory in association with the user information; in a case where the storing instruction is received from the terminal device, store the device information in a first state in the memory in association with the user information, wherein the first state is a state where the server does not permit provision of the service which uses the device information; and in a case where the terminal device receives the user’s approval for subscription to the service in the first prompt screen, change a state of the device information in the memory from the first state to a second state where the server permits provision of the service which uses the device information.

According to the above configuration, the server stores the device information in association with the user information in the memory while the setup process is ongoing. Then, when a user’s approval is received in the prompt screen displayed after the end of the setup, the server permits provision of the service which uses the device information in the memory. The service is provided quickly after the end of the setup process, by which user convenience can be improved.

A non-transitory computer-readable recording medium storing computer-readable instructions for the server and a control method of the above-described server are also novel and useful.

Another aspect of a non-transitory computer-readable recording medium storing computer-readable instructions for a terminal device is disclosed herein. The computer-readable instructions, when executed by a processor of the terminal device, may cause the terminal device to: in a case where a predetermined instruction is inputted, send, to an image processing device different from the terminal device, a request so as to receive device information related to the image processing device from the image processing device as information for subscribing to a service for the image processing device; in the case where the predetermined instruction is inputted, send, to a management device which manages user information related to a user of the image processing device, a request so as to receive the user information from the management device as information for subscribing to the service for the image processing device; in a case where the device information is received from the image processing device and the user information is received from the management device, display a prompt screen on a display unit of the terminal device, wherein the prompt screen is for displaying at least the user information among the device information and the user information and prompting to subscribe to the service by using the device information and the user information, and the prompt screen includes an object for receiving the user’s approval; and in a case where the object included in the prompt screen is selected, execute a subscription process for subscribing to the service.

In order to subscribe to the service, not only the device information but also the user information is necessary. According to the above configuration, the user information is managed by the management device. Then, the terminal device receives the user information from the management device, in addition to receiving the device information from the image processing device. The user can subscribe to the service simply by approving subscription to the service in the prompt screen displayed after inputting the predetermined instruction. The user can subscribe to the service quickly after inputting the predetermined instruction, by which user convenience can be improved.

The above-described terminal device itself and a control method of the above-described terminal device are also novel and useful.

A communication system is disclosed herein. The communication system may include a terminal device; an image processing device configured to communicate with the terminal device; and a management device configured to communicate with the terminal device and manage user information related to a user of the image processing device, wherein the terminal device is configured to: in a case where a predetermined instruction is inputted, send the image processing device a first request for requesting device information related to the image processing device; and in the case where the predetermined instruction is inputted, send the management device a second request for requesting the user information, wherein the image processing device is configured to send the terminal device the device information according to the first request, and the management device is configured to send the terminal device the user information according to the second request, wherein the terminal device is further configured to: in a case where the device information is received from the image processing device and the user information is received from the management device, display a prompt screen on a display unit of the terminal device, wherein the prompt screen is for displaying at least the user information among the device information and the user information and prompting to subscribe to the service by using the device information and the user information, and the prompt screen includes an object for receiving the user’s approval; and in a case where the object included in the prompt screen is selected, execute a subscription process for subscribing to the service.

With the above configuration also, the user can subscribe to the service quickly after inputting the predetermined instruction, by which user convenience can be improved.

### BRIEF DESCRIPTION OF DRAWINGS

FIG. 1 illustrates a schematic view of a communication system.

FIG. 2 illustrates a block diagram of a service providing server.

FIG. 3 illustrates a block diagram of an account management server.

FIG. 4 illustrates a block diagram of a terminal device.

FIG. 5 illustrates a block diagram of a printer.

FIG. 6 illustrates a sequence diagram of processes realized by a communication system.

FIG. 7 illustrates a sequence diagram of continuation from FIG. 6.

FIG. 8 illustrates a sequence diagram when a user does not approve.

FIG. 9 illustrates a sequence diagram when a user does not approve.

FIG. 10 illustrates a sequence diagram of processes realized by a communication system.

FIG. 11 illustrates a sequence diagram when a user does not approve.

FIG. 12 illustrates a sequence diagram when a user does not approve.

### DESCRIPTION

### First Embodiment

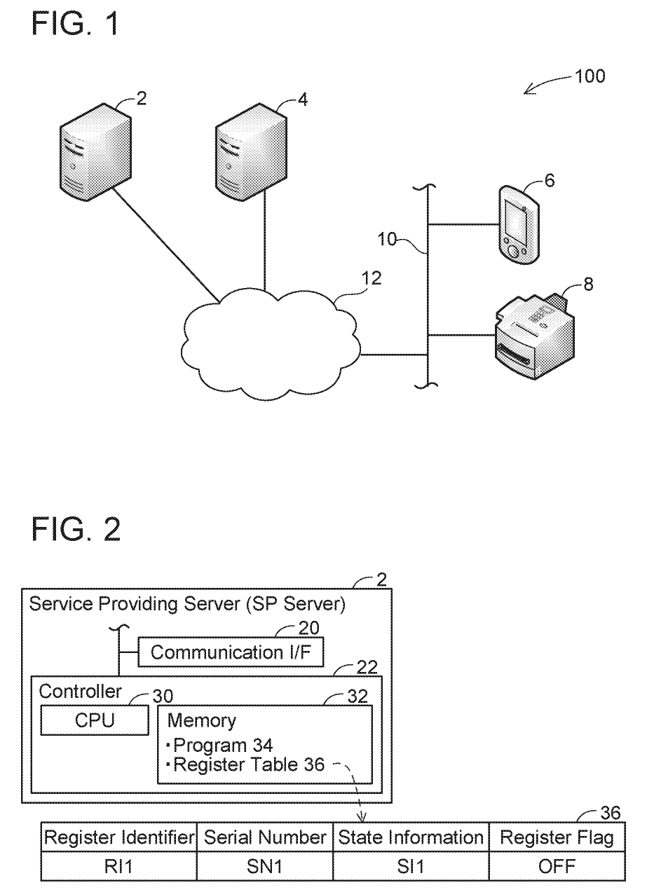

### Configuration of Communication System 100; FIG. 1

A communication system 100 comprises a service providing server 2, an account management server 4, a terminal device 6, and a printer 8. The terminal device 6 is a laptop PC, a smartphone, a tablet terminal, a desktop PC, for example. The printer 8 is a peripheral device for the terminal device 6, and has a print function. Hereafter, the service providing server will be termed “SP server”, and the account management server 4 will be termed “AM server”.

The terminal device 6 and the printer 8 are connected to the LAN 10. The LAN 10 is a Local Area Network. The LAN 10 is wired or wireless. The LAN 10 is connected to the Internet 12. The SP server 2 and the AM server 4 are connected to the Internet 12. The terminal device 6 is configured to communicate with the printer 8 via the LAN 10. Also, the terminal device 6 and the printer 8 are configured to communicate with the SP server 2 and the AM server 4 via the LAN 10 and the Internet 12.

### Configuration of SP Server 2; FIG. 2

The SP server 2 provides a service related to the printer 8. Such service is for example a subscription service. In the subscription service, only a basic fee is charged when the number of printed sheets within a predetermined period such as one month is equal to or less than an upper limit number of printed sheets such as 1000 sheets. Also, when the number of printed sheets within a unit period exceeds the upper limit number of printed sheets, a sum of the basic fee and an excess fee according to the number of printed sheets exceeding the upper limit number of printed sheets is charged. In other words, the subscription service is a service which permits printing of the upper limit number of printed sheets or less during the predetermined period at the basic fee. The subscription service includes an automatic delivery service. The automatic delivery service is a service which delivers a new cartridge when the remaining level of color material in a color cartridge mounted in the printer 8 becomes equal to or less than a predetermined remaining level. The color material mentioned herein is for example ink, toner. The fee of the cartridge is included in the basic fee of the subscription service.

The SP server 2 may provide service(s) other than the subscription service. For example, the SP server 2 may provide an automatic ordering service, a guaranty service, and a remote printing service, for example. The automatic ordering service is a service which automatically orders a new cartridge when the remaining level of the color material mounted in the printer 8 becomes equal to or less than the predetermined remaining level. In the automatic ordering service, a monthly basic fee does not exist, thus the fee of the cartridge is charged for each order. The automatic ordering service also includes the automatic delivery service as the subscription service does. The guaranty service is a service which provides a guaranty for the printer 8. The remote printing service is a service which remotely causes the printer 8 to execute printing via the Internet 12.

The SP server 2 comprises a communication interface 20 and a controller 22. Hereafter, an interface will be termed “I/F”. The communication I/F 20 is an I/F for executing communication via the Internet 12. The communication I/F 20 is connected to the Internet 12.

The controller 22 comprises a CPU 30 and a memory 32. The memory 32 comprises a primary storage and an auxiliary storage. Although this is an example, the primary storage includes a RAM and cache memory. Although this is an example, the auxiliary storage is a ROM, a flash memory, a Solid State Drive (SSD), a Hard Disk Drive (HDD), or a combination thereof. The CPU 30 realizes various processes in accordance with a program 34 loaded from the auxiliary storage to the primary storage.

The memory 32 further stores a registration table 36. The registration table 36 is a table in which information related to the printer 8 is registered. The registration table 36 stores, for each of one or more printers 8, a registration identifier, a serial number, status information, and a registration flag in association with each other. The registration identifier is an identifier which is issued by the SP server 2 on the corresponding printer 8. The serial number is information identifying the corresponding printer 8, and is obtained from the printer 8. The status information is information indicating the status of the corresponding printer 8, and is obtained from the printer 8. The status information includes for example the remaining level of a color cartridge mounted in the printer 8.

The registration flag indicates either “ON” indicating that the registration of the subscription service for the corresponding printer 8 has been completed or “OFF” indicating that such registration has not been completed. The default value of the registration flag is “OFF”. In the registration flag “OFF”, provision of the subscription service to the corresponding printer 8 is not permitted. Contrary to this, in the registration flag “ON”, provision of the subscription service to the corresponding printer 8 is permitted.

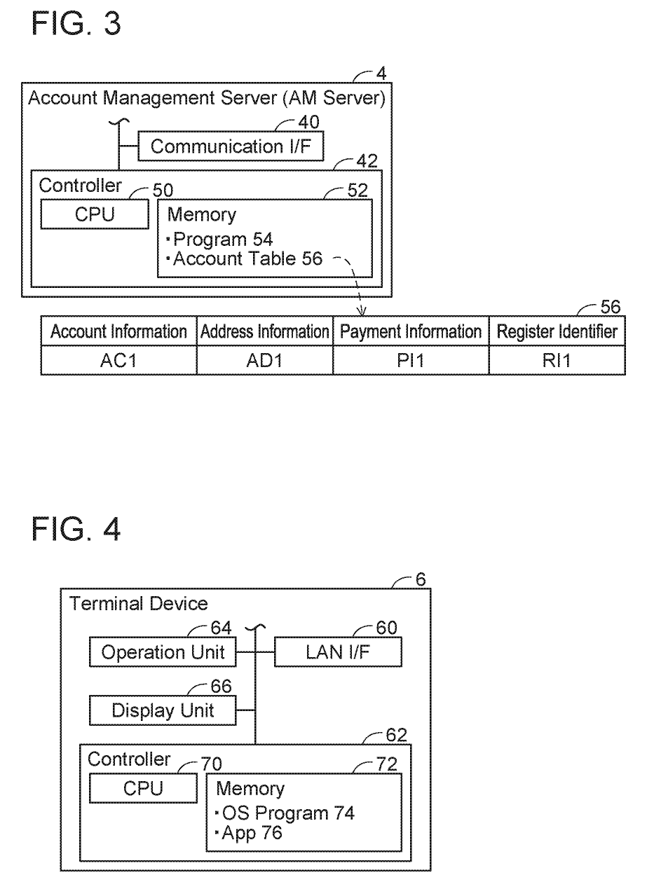

### Configuration of AM server 4; FIG. 3

The AM server 4 is a server which manages information related to the user of the printer 8. The AM server 4 comprises a communication I/F 40 and a controller 42. The communication I/F 40 is connected to the Internet 12. The controller 42 comprises a CPU 50 and a memory 52. The CPU 50 realizes various processes in accordance with a program 54 stored in the memory 52.

The memory 52 further stores an account table 56. The account table 56 stores, for each of one or more users, account information, address information, payment information, and a register identifier in association with each other. The account information is an account name and a password which identify the corresponding user. The account name simply needs to be information by which the user can be identified, and for example, is an email address. The address information indicates the address of the corresponding user. The payment information is information for the corresponding user to pay the fee of the subscription service. The payment information is for example, a credit card number. The register identifier is provided by the SP server 2.

### Configuration of Terminal Device 6; FIG. 4

The terminal device 6 comprises a LAN I/F 60, a controller 62, an operation unit 64, and a display unit 66. The operation unit 64 is a user interface which allows a user to input various information to the terminal device 6. The operation unit 64 comprises, for example, a touch panel for displaying software key(s), hardware key(s), or both of them. The software key(s) are object(s) such as icon(s), tab(s), button(s), and box(es). The hardware key(s) may for example be button(s) and switch(es). The display unit 66 is a display or a panel for displaying various information. The panel may be a touch panel or may not be a touch panel. Here, the panel is a liquid crystal panel, an organic EL panel, for example. The LAN I/F 60 is an I/F configured to execute communication via the LAN 10, and is connected to the LAN 10.

The controller 62 comprises a CPU 70 and a memory 72. The memory 72 comprises a primary storage and an auxiliary storage. The auxiliary storage has an OS program 74 and an application program 76 stored therein. Hereafter, the application program will be termed “app”. The CPU 30 realizes various processes in accordance with the programs 74 and 76 loaded from the auxiliary storage to the primary storage.

The OS program 74 controls basic operations of the terminal device 6. The app 76 is a program which executes a setup process of setting up the printer 8. The setup process is a process for initial settings for starting to use the printer 8. The app 76 is provided by, for example, a vendor of the printer 8. The app 76 is installed on the terminal device 6 from, for example, a server on the Internet.

The setup includes, for example, a setup operation and setup communication. The setup operation is an operation for which physical operation on the printer 8 is necessary. The setup communication is a setup which includes communication between the terminal device 6 and the printer 8.

The setup operation is, for example, mounting a color cartridge on the printer 8 and/or operational tests of several functions carried out by operating the printer 8. Also, when the printer 8 comprises an electrophotographic print engine, the setup operation may include an operation of adjusting the position at which the laser beam is ejected in the electrophotographic process. The setup communication is, for example, sending of a signal for requesting for test printing, sending of firmware update information, acquisition of information related to the printer 8, and/or writing an MIB value.

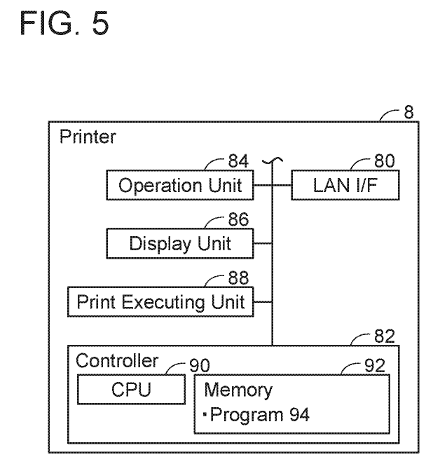

### Configuration of Printer 8; FIG. 5

The printer 8 comprises a LAN I/F 80, a controller 82, an operation unit 84, a display unit 86, and a print executing unit 88. The operation unit 84 is for example a touch panel, and the display unit 86 is for example a liquid crystal panel.

The print executing unit 88 comprises an inkjet print engine, an electrophotographic print engine, or a thermal print engine. The print executing unit 88 is configured to have color cartridge(s) connected thereto.

The LAN I/F 80 is connected to the LAN 10. The controller 82 comprises a CPU 90 and a memory 92. The memory 92 comprises a primary storage and an auxiliary storage. The auxiliary storage has a program 94 stored therein. The CPU 30 realizes various processes in accordance with the program 94 loaded from the auxiliary storage to the primary storage.

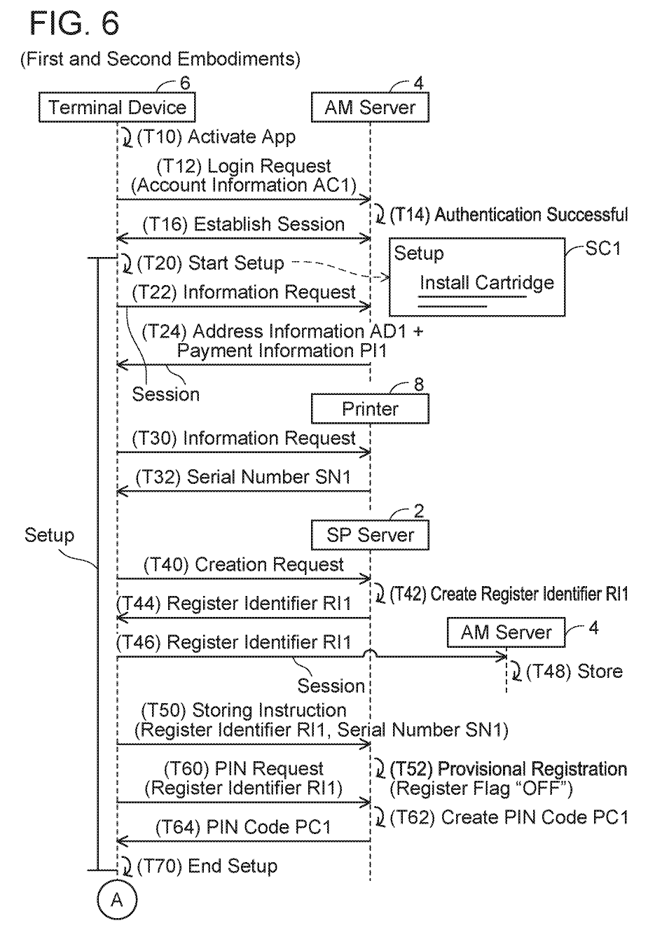

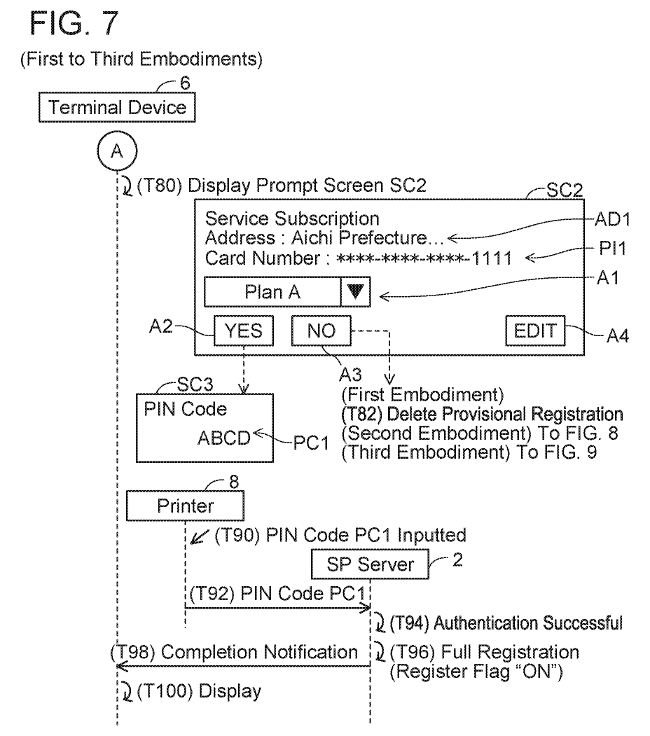

### Processes Realized by Communication System 100; FIGS. 6, 7

With reference to FIGS. 6 and 7, processes realized by the communication system 100 will be described. In the following processes, communication between two devices is executed via the LAN I/F 60, the LAN 10, the Internet 12, and the communication I/F 40. In the following description, descriptions of the network and I/F related to the communication between two devices will be omitted.

In the initial state of a case shown in FIGS. 6 and 7, the account table 56 has address information AD1 and payment information PI1 stored in advance in association with account information AC1. In the initial state of the present case, the account table 56 does not have a register identifier stored in association with the account information AC1.

In T10, the terminal device 6 activates the app 76 in accordance with an instruction inputted on the operation unit 64 from the user. Among processes of T12 and thereafter, a process executed by the terminal device 6 is executed in accordance with the app 76.

n T12, the terminal device 6 sends the AM server 4 a login request which requests for login to the AM server 4. The login request includes the account information AC1 inputted on the operation unit 64 by the user.

When the AM server 4 receives the login request from the terminal device 6 in T12, the AM server 4 authenticates the account information AC1 included in the login request. In the present case, the account information AC1 included in the login request matches the account information AC1 stored in the account table 56. Due to this, in T14, the authentication of the account information AC1 included in the login request succeeds.

When the account information AC1 is successfully authenticated, the AM server 4 establishes a login session between the AM server 4 and the terminal device 6 in T16. Hereafter, the login session established in T16 will be termed “target session”.

When the target session is established, the terminal device 6 starts the setup process of setting up the printer 8 in T20. Specifically, the terminal device 6 displays a setup screen SC1 which prompts execution of setup on the display unit 66. The setup screen SC1 includes an image which prompts steps of the setup operation and the setup communication. The user executes the setup operation and the setup communication according to the setup screen SC1.

The terminal device 6 executes processes from T22 to T64 during a period from start until end of the setup process. The processes from T22 to T64 are executed on background of the setup process. Here, the end of the setup process means the end of all the steps shown on the setup screen SC1.

In T22, the terminal device 6 sends an information request which requests various information to the AM server 4 by using the target session.

When the AM server 4 receives the information request from the terminal device 6 in T22, the AM server 4 sends a response to the information request to the terminal device 6 in T24. Specifically, the AM server 4 specifies the address information AD1 and the payment information PI1 that are stored in association with the account information AC1 corresponding to the target session. Then, the AM server 4 sends the address information AD1 and the payment information PI1 that are specified to the terminal device 6 by using the target session.

Also, in T30, the terminal device 6 sends the information request which requests various information to the printer 8 in the LAN 10. In the present case, the printer 8 has a serial number SN1 identifying the printer 8 stored therein.

When the printer 8 receives the information request from the terminal device 6 in T30, the printer 8 sends the serial number SN1 as a response to the information request to the terminal device 6 in T32.

Through the processes from T22 to T32, the terminal device 6 collects information for subscribing to the subscription service for the printer 8. The information for subscribing to the subscription service for the printer 8 is the address information AD1, the payment information PI1, and the serial number SN1.

In the subsequent T40, the terminal device 6 sends a creation request which requests for creation of a register identifier to the SP server 2. In T42, the SP server 2 creates a register identifier RI1 in accordance with the creation request received from the terminal device 6. Then, the SP server 2 sends the created register identifier RI1 to the terminal device 6 in T44.

The terminal device 6 receives the register identifier RI1 from the SP server 2 in T44. The terminal device 6 sends the register identifier RI1 to the AM server 4 by using the target session in T46.

The AM server 4 receives the register identifier RI1 from the terminal device 6 in T46. The AM server 4 stores the register identifier RI1 in the account table 56 in association with the account information AC1 corresponding to the target session in T48. Due to this, the register identifier RI1 is shared between the SP server 2 and the AM server 4. The SP server 2 can specify the address information AD1 and the payment information PI1 from the AM server 4, by using the register identifier RI1.

The terminal device 6 sends a storing instruction which instructs to store various information to the SP server 2 in T50. The storing instruction includes the register identifier RI1 and the serial number SN1.

The SP server 2 receives the storing instruction from the terminal device 6 in T50. The SP server 2 stores the serial number SN1 included in the storing instruction in the registration table 36 in T52. Specifically, the SP server 2 stores the serial number SN1 included in the storing instruction in the registration table 36 in association with the register identifier RI1 included in the storing instruction. Further, the SP server 2 stores the registration flag “OFF” in the registration table 36 in association with the register identifier RI1 included in the storing instruction. In the present specification, a situation where the register identifier RI1 and the serial number SN1 are stored but the registration flag indicates “OFF” will be termed “provisional registration”. In the provisional registration, provision of the subscription service to the printer 8 identified by the serial number SN1 corresponding to the register identifier RI1 is not permitted.

Also, in T60, the terminal device 6 sends the SP server 2 a PIN request which requests a PIN code to be issued. The PIN code is a code for authenticating the printer 8 for which the subscription service is used, and restricts unauthorized usage by a third party of the subscription service. The PIN request includes the register identifier RI1.

When the SP server 2 receives the PIN request from the terminal device 6 in T60, the SP server 2 creates a PIN code PC1 in T62. The SP server 2 stores the PIN code PC1 in association with the register identifier RI1 included in the PIN request. Then, the SP server 2 sends the PIN code PC1 to the terminal device 6 in T64.

In the subsequent T70, the setup process which was started in T20 ends. For example, the terminal device 6 displays a screen indicating that the setup process has ended on the display unit 66.

When the setup process has ended, in T80 of FIG. 7, the terminal device 6 displays a prompt screen SC2 on the display unit 66. The prompt screen SC2 is a screen which prompts to subscribe to the subscription service by using the information that has been collected from T22 to T32 in FIG. 6. The prompt screen SC2 displays a character string indicating the address information AD1 received in T24 and a character string indicating the payment information PI1 received in T24. In the case of FIG. 7, a credit card number is displayed as the payment information PI1. In this case, only the last four digits of the credit card number may be displayed and the other digits may not be displayed.

The prompt screen SC2 further includes a selection object A1, a YES button A2, a NO button A3, and an EDIT button A4. The selection object A1 is an object for selecting a plan of the subscription service. For example, the subscription service may have a plurality of plans with different upper limit numbers of printed sheets. The YES button A2 is a button for approving of subscribing to the subscription service. The NO button A3 is a button for not approving of subscribing to the subscription service. The EDIT button A4 is a button for editing the address information AD1 or the payment information PI1.

For example, when the EDIT button A4 is selected, the terminal device 6 displays an edit screen for editing the address information AD1 or the payment information PI1 on the display unit 66. The terminal device 6 sends new address information or new payment information that is inputted on the edit screen to the AM server 4. Due to this, the address information AD1 or the payment information PI1 is edited.

In one case, a user wishes to subscribe to the subscription service, and selects the YES button A2. When the YES button A2 is selected, the terminal device 6 displays a code screen SC3 on the display unit 66. The code screen SC3 displays the PIN code PC1 received in T64 of FIG. 6. Also, when the YES button A2 is selected, the terminal device 6 sends plan information indicating the plan selected at the selection object A1 to the SP server 2. When the SP server 2 receives the plan information from the terminal device 6, the SP server 2 stores the plan information in association with the register identifier RI1. Due to this, the plan of the subscription service provided to the printer 8 identified by the serial number SN1 is determined.

The user inputs the PIN code PC1 displayed on the code screen SC3 into the operation unit 84 of the printer 8 in T90. The printer 8 sends the PIN code PC1 inputted in T90 to the SP server 2 in T92.

When the SP server 2 receives the PIN code PC1 from the printer 8 in T92, the SP server 2 authenticates the PIN code PC1. In the present case, the PIN code PC1 received from the printer 8 matches the PIN code PC1 stored in the SP server 2. Due to this, the PIN code PC1 received from the printer 8 is successfully authenticated in T94.

In response to the successful authentication of the PIN code PC1, the SP server 2 specifies the register identifier RI1 stored in association with the PIN code PC1. Then, the SP server 2 changes the registration flag stored in association with the specified register identifier RI1 from “OFF” to “ON” in T96. In the present specification, a situation where the register identifier RI1, the serial number SN1, and the registration flag “ON” are stored will be termed “full registration”. In the full registration, provision of the subscription service to the printer 8 identified by the serial number SN1 is permitted. Here, when the authentication of the PIN code PC1 succeeds, association of the serial number SN1 and the account information AC1 with each other via the register identifier RI1 has been completed. The association between the serial number SN1 and the account information AC1 enables change from the provisional registration to the full registration.

When the full registration is completed in T96, the SP server 2 sends a completion notification indicating that the full registration has been completed to the terminal device 6 in T98.

When the completion notification has been received from the SP server 2 in T98, the terminal device 6 displays a screen indicating that the full registration has been completed on the display unit 66 in T100.

Also, in another case, the user does not wish to subscribe to the subscription service, and thus selects the NO button A3. When the NO button A3 is selected, the terminal device 6 sends a deletion instruction which instructs to delete the provisional registration to the SP server 2 in T82. The deletion instruction includes the register identifier RI1. When the SP server 2 receives the deletion instruction, the SP server 2 deletes all the information stored in association with the register identifier RI1 and the register identifier RI1 from the registration table 36. Due to this, the provisional registration corresponding to the register identifier RI1 is deleted. The register identifier RI1 and the serial number SN1 that are stored in the provisional registration can be prevented from being unnecessarily retained in the SP server 2.

### Effects of Present Embodiment

According to the configuration of the present embodiment, while the setup process is ongoing, the information for subscribing to the subscription service is collected (T24 and T32 in FIG. 6). The user can subscribe to the subscription service simply by approving subscription to the subscription service on the prompt screen SC2 displayed after the end of the setup process. The user can subscribe to the subscription service immediately after the end of the setup process, by which user convenience can be improved.

Also, in order to subscribe to the subscription service, not only the serial number SN1 but also the address information AD1 and the payment information PI1 are necessary. According to the configuration of the present embodiment, the address information AD1 and the payment information PI1 are managed by the AM server 4. Then, in response to the instruction for activating the app 76, the terminal device 6 receives the serial number SN1 from the printer 8 (T32 in FIG. 6). The terminal device 6 also receives, in addition to the serial number SN1, the address information AD1 and the payment information PI1 from the AM server 4 (T24 in FIG. 6). The user can subscribe to the subscription service simply by approving subscribing to the subscription service on the prompt screen SC2 displayed after the instruction for activating the app 76. The user can subscribe to the subscription service immediately after the instruction for activating the app 76, by which user convenience can be improved.

Also, while the setup process is ongoing, the SP server 2 stores the serial number SN1 in the registration table 36 in association with the register identifier RI1 (T52 in FIG. 6). The register identifier RI1 is stored in association with the address information AD1 and the payment information PI1 at the AM server 4. That is, in the provisional registration, the serial number SN1 is stored in the registration table 36 in association with the address information AD1 and the payment information PI1. Then, when the user’s approval is obtained in the prompt screen SC2 displayed after the end of the setup process, the SP server 2 changes the provisional registration to the full registration (T96 in FIG. 7). In the full registration, provision of the subscription service which uses the information stored in the provisional registration is permitted. The subscription service is provided immediately after the end of the setup process, by which user convenience can be improved.

The terminal device 6 also sends the storing instruction to the SP server 2 during a period from the start until the end of the setup process (T50 in FIG. 6). Due to this, the information for subscribing to the subscription service is stored in the provisional registration in the SP server 2 (T52). The SP server 2 can be caused to store the information for subscribing to the subscription service in advance during the period from the start until the end of the setup process.

### Correspondence Relationships

The terminal device 6, the app 76, and the display unit 66 are respectively an example of “terminal device”, “non-transitory computer-readable recording medium”, and “display unit”. The printer 8 is an example of “image processing device”. The SP server 2, the memory 32, and the AM server 4 are respectively an example of “server”, “memory”, and “management device”. The instruction for activating in T10 in FIG. 6 is an example of “predetermined instruction”. The setup process started by T20 and the setup screen SC1 are an example of “setup process” and “specific screen”, respectively. The subscription service is an example of “service”. The address information AD1 and the payment information PI1 are an example of “user information”. The serial number SN1 is an example of “device information” and “identification information”. The prompt screen SC2 is an example of “prompt screen” and “first prompt screen”. The YES button A2 is an example of “first object”. The displaying of the code screen SC3 is an example of “subscription process”. The PIN code PC1 and the register identifier RI1 are an example of “authentication information” and “specifying information”. The storing instruction in T50 in FIG. 6 and the deletion instruction in T82 in FIG. 7 are an example of “first storing instruction” and “deletion instruction”. The provisional registration in T52 of FIG. 6 and the full registration in T96 in FIG. 7 are an example of “first state” and “second state”.

T20 in FIG. 6 is an example of a process realized by “start a setup process”. T22 to T32 in FIG. 6 are an example of processes realized by “collect subscription information”. T32, T24 in FIG. 6 are respectively an example of processes realized by “receive device information”, “receive the user information”. T80 in FIG. 7 is an example of a process realized by “display a prompt screen”. The displaying of the code screen SC3 is an example of a process realized by “execute a subscription process”.

T50, T52 in FIG. 6 and T96 in FIG. 7 are respectively an example of “receive a storing instruction”, “store the device information”, and “change a state of the device information”.

### Second Embodiment

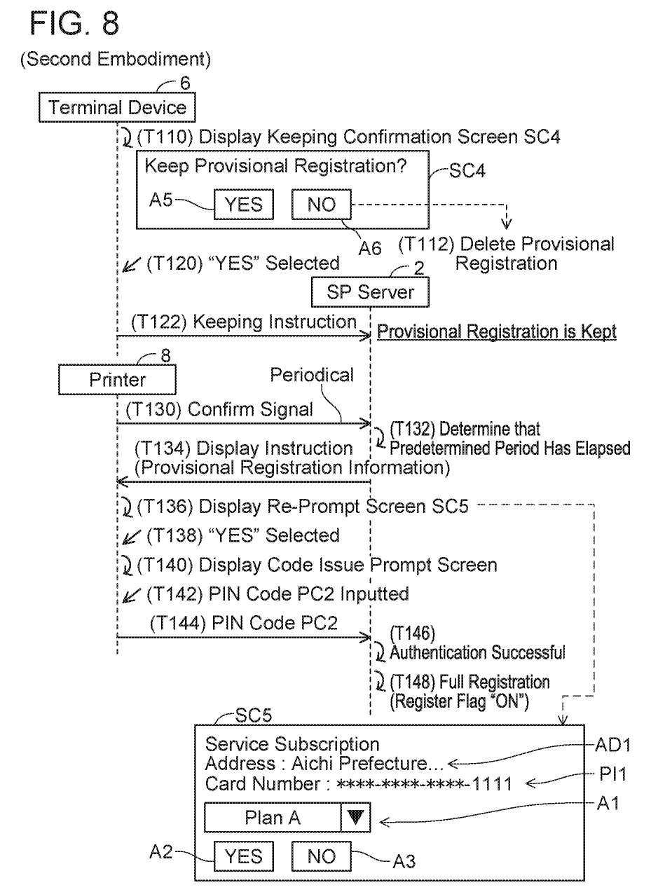

A communication system 100 of the present embodiment executes processes of FIG. 8 when the NO button A3 on the prompt screen SC2 of FIG. 7 is selected. The communication system 100 of the present embodiment has the same configuration as that of the communication system 100 of the first embodiment except the processes of FIG. 8 being executed.

### Processes in Response to Selection of NO button A3; FIG. 8

In T110, the terminal device 6 displays a keeping confirmation screen SC4 for confirming whether to temporarily keep the provisional registration in T52 in FIG. 6 on the display unit 66. The keeping confirmation screen SC4 includes a YES button A5 for approving of temporarily keeping the provisional registration and a NO button A6 for not approving of temporarily keeping the provisional registration.

When the NO button A6 on the keeping confirmation screen SC4 is selected, the terminal device 6 proceeds to T112. T112 is the same as T82 in FIG. 7, and the provisional registration is deleted.

Also, when the YES button A5 on the keeping confirmation screen SC4 is selected, the terminal device 6 proceeds to T122. In T122, the terminal device 6 sends a keeping instruction which instructs to temporarily keep the provisional registration to the SP server 2. Due to this, the provisional registration is temporarily kept.

In the present embodiment, after the end of the setup process, the printer 8 periodically sends a confirm signal which confirms the condition of the provisional registration to the SP server 2.

When the SP server 2 receives the confirm signal from the printer 8 in T130, the SP server 2 proceeds to T132. In T132, the SP server 2 determines whether a predetermined time has elapsed since the date and time when the provisional registration for the printer 8 from which the confirm signal was sent was kept. The predetermined time is for example one week. If it is determined that the predetermined time has not elapsed since the date and time when the provisional registration was kept, the SP server 2 does not execute processes of T134 and thereafter to be described later, but stands by for receiving a next confirm signal.

When the SP server 2 determines that the predetermined time has elapsed since the date and time when the provisional registration was kept, the SP server 2 proceeds to T134. In T134, the SP server 2 sends a display instruction which instructs to display a re-prompt screen SC5 to the printer 8. The re-prompt screen SC5 is a screen which re-prompts to subscribe to the subscription service by using the information kept as the provisional registration. The re-prompt screen SC5 displays, similar to the prompt screen SC2 of FIG. 7, a character string indicating the address information AD1 and a character string indicating the payment information PI1. Also, the re-prompt screen SC5 includes the selection object A1, the YES button A2, and the NO button A3. The re-prompt screen SC5 may or may not include the EDIT button A4.

The display instruction includes provisional registration information. The SP server 2 obtains the address information AD1 and the payment information PI1 that are stored in association with the register identifier RI1 corresponding to the printer 8, from which the confirm signal was sent, from the AM server 4. The provisional registration information includes the address information AD1 and the payment information PI1 that are obtained from the AM server 4.

When the printer 8 receives the display instruction from the SP server 2 in T134, the printer 8 displays the re-prompt screen SC5 on the display unit 86 in T136. When the YES button A2 on the re-prompt screen SC5 is selected in T138, the printer 8 proceeds to T140. If the NO button A3 on the re-prompt screen SC5 is selected, the processes of T140 and thereafter are not executed, and the processes of FIG. 8 end.

In T140, the printer 8 displays a code issue prompt screen on the display unit 86. The code issue prompt screen is a screen which prompts steps for sending a PIN request to the terminal device 6. By the user operating the terminal device 6 according to the code issue prompt screen, the processes of T60 to T64 in FIG. 6 are executed, as a result of which a new PIN code PC2 is issued. Then, the terminal device 6 displays the PIN code PC2 on the display unit 66.

T142 to T148 are the same as T90 to T96 in FIG. 7 except that the PIN code PC2 is used. That is, the provisional registration that was kept temporarily is changed to the full registration, and provision of the subscription service is permitted.

According to the configuration of the present embodiment, the information collected from the start until the end of the setup process is temporarily kept as the provisional registration in the SP server 2. Then, the re-prompt screen SC5 is used to re-prompt subscribing to the subscription service. The user can be reminded of subscribing to the subscription service again, by which user convenience can be improved.

Also, the re-prompt screen SC5 is displayed on the printer 8. The user can see the re-prompt screen SC5 when using the printer 8.

### Correspondence Relations

The keeping confirmation screen SC4, the YES button A5 are respectively an example of “confirmation screen”, “second object”. The re-prompt screen SC5 in T136 of FIG. 8 is an example of “third prompt screen”.

### Third Embodiment

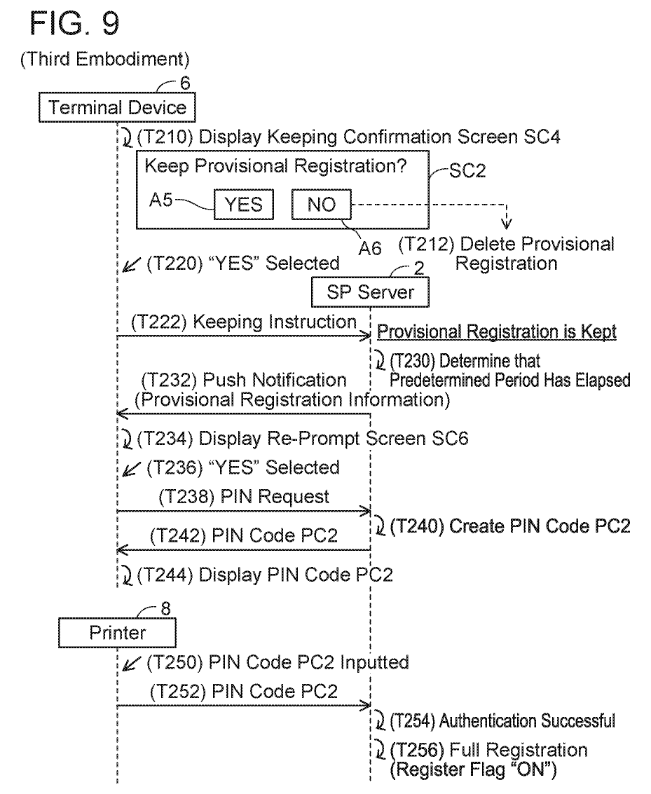

The communication system 100 of the present embodiment executes processes of FIG. 9 when the NO button A3 on the prompt screen SC2 of FIG. 7 is selected. The communication system 100 of the present embodiment has the same configuration as the communication system 100 of the first embodiment except that the processes of FIG. 9 are executed.

T210 to T222 are the same as T110 to T122 in FIG. 8. In T230, the SP server 2 determines whether a predetermined time has elapsed since the date and time when the provisional registration was kept in T222. If it is determined that the predetermined time has not elapsed, the SP server 2 repeats the determination of T230 without executing processes of T232 and thereafter to be described later.

When the SP server 2 determines that the predetermined time has elapsed since the date and time when the provisional registration was kept, the SP server 2 proceeds to T232. In T232, the SP server 2 sends a push notification including the provisional registration information to the terminal device 6. The push notification is a function of displaying a notification on the terminal device 6 without receiving a request from the terminal device 6.

When the terminal device 6 receives the push notification from the SP server 2 in T232, the terminal device 6 displays a re-prompt screen SC6 on the display unit 66 in T234. The re-prompt screen SC6 is the same as the prompt screen SC2 of FIG. 7.

When the YES button A2 on the re-prompt screen SC6 is selected in T236, the terminal device 6 proceeds to T238. If the NO button A3 on the re-prompt screen SC6 is selected, the processes of T238 and thereafter are not executed, and the processes of FIG. 9 end.

T238 to T242 are the same as T60 to T64 in FIG. 7 except that the new PIN code PC2 is issued. In T244, the terminal device 6 displays the PIN code PC2 on the display unit 66.

T250 to T256 are the same as T90 to T96 in FIG. 7. That is, the provisional registration that was kept temporarily is changed to the full registration, by which provision of the subscription service is permitted.

In the present embodiment also, the user can be reminded of subscribing to the subscription service, by which user convenience can be improved. Also, the re-prompt screen SC6 is displayed on the terminal device 6. The user can see the re-prompt screen SC6 when using the terminal device 6. The re-prompt screen SC6 in T234 in FIG. 9 is an example of “second prompt screen”.

### Fourth Embodiment

In the present embodiment, a registration flag is not stored in the registration table 36. That is, the SP server 2 of the present embodiment does not have the function of provisional registration.

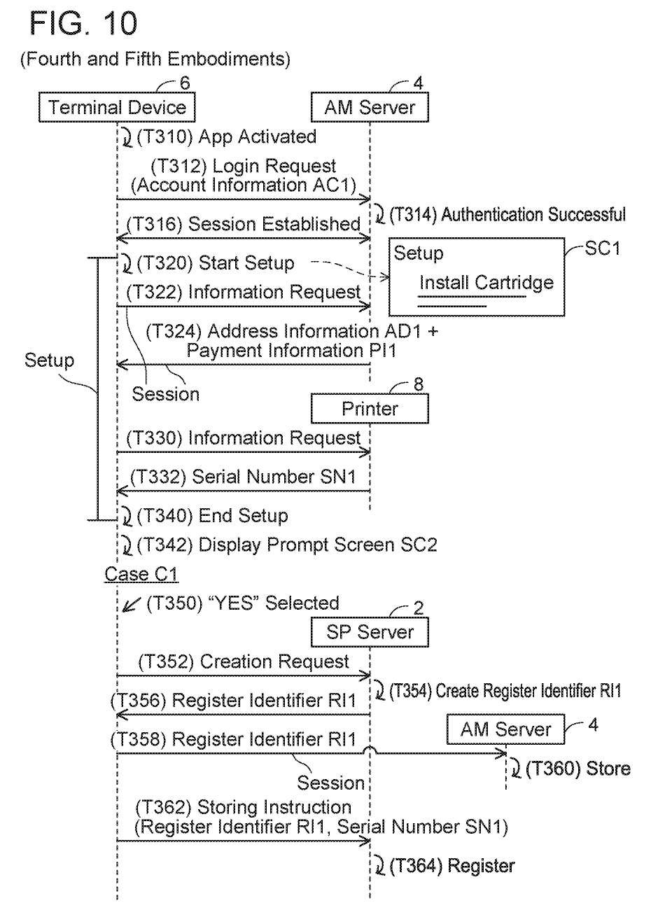

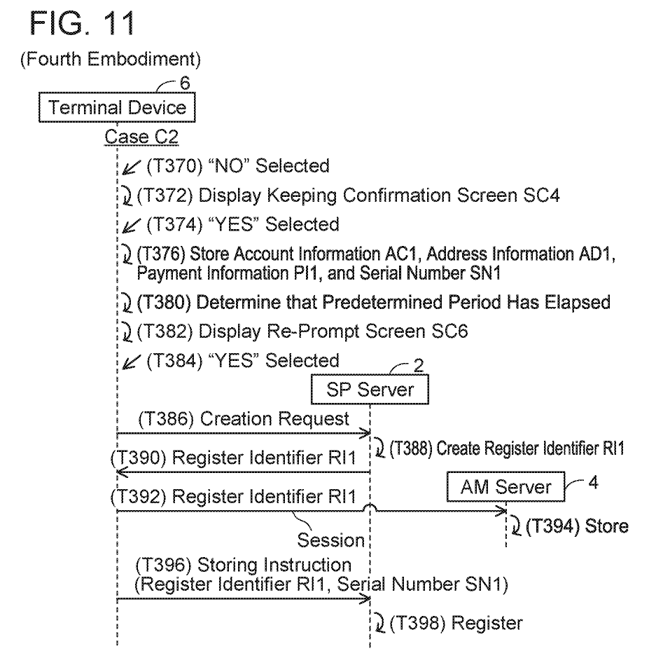

### Processes Realized by Communication System 100; FIGS. 10, 11

With reference to FIGS. 10 and 11, the processes realized by the communication system 100 of the present embodiment will be described.

T310 to T316 are the same as T10 to T16 in FIG. 6. The terminal device 6 starts the setup process of the printer 8 in the subsequent T320. In the present embodiment, the terminal device 6 executes the processes of T322 to T332 from the start until the end of the setup process. T322 to T332 are the same as T22 to T32 in FIG. 6. In the present embodiment, the processes of T40 to T64 in FIG. 6 are not executed during a period from the start until the end of the setup process. In T340, the setup process started in T320 ends.

In T342, the terminal device 6 displays the prompt screen SC2 on the display unit 66. Case C1 of FIG. 10 is a case where, in the present embodiment, the YES button A2 on the prompt screen SC2 is selected. Case C2 of FIG. 11 is a case where, in the present embodiment, the NO button A3 on the prompt screen SC2 is selected.

### Case C1; FIG. 10

When the YES button A2 on the prompt screen SC2 is selected in T350, the terminal device 6 proceeds to T352. T352 to T360 are the same as T40 to T48 in FIG. 6. That is, the register identifier RI1 is shared between the SP server 2 and the AM server 4.

T362 is the same as T50 in FIG. 6. When the SP server 2 receives the storing instruction from the terminal device 6 in T362, the SP server 2 proceeds to T364. In T364, the SP server 2 stores the serial number SN1 included in the storing instruction in the registration table 36. As described above, in the present embodiment, the SP server 2 does not have the function of the provisional registration. In the present embodiment, the registration in T364 enables to permit provision of the subscription service to the printer 8 identified by the serial number SN1 corresponding to the register identifier RI1.

In the present case, when the YES button A2 is selected on the prompt screen SC2 after the end of the setup process, processes of T352 to T364 are executed. Due to this, the user can subscribe to the subscription service, simply by approving subscription to the subscription service on the prompt screen SC2 displayed after the end of the setup process. The user can subscribe to the subscription service immediately after the end of the setup process, by which user convenience can be improved.

### Case C2; FIG. 11

When the NO button A3 on the prompt screen SC2 is selected in T370, the terminal device 6 proceeds to T372. In T372, the terminal device 6 displays the keeping confirmation screen SC4 the same as T110 in FIG. 8 on the display unit 66. When the YES button A5 on the keeping confirmation screen SC4 is selected in T374, the terminal device 6 proceeds to T376. In T376, the terminal device 6 temporarily stores the account information AC1 used for the login of T312 and the information collected through T322 to T332 in the memory 72. The information collected through T322 to T332 is the address information AD1, the payment information PI1, and the serial number SN1.

In T380, the terminal device 6 determines whether a predetermined time has elapsed since the date and time when the information was temporarily stored in T376. If it is determined that the predetermined time has not elapsed, the terminal device 6 does not execute the processes of T382 and thereafter to be described later, but repeats the determination of T380.

When the terminal device 6 determines that the predetermined time has elapsed since the date and time when the information was temporarily stored, the terminal device 6 proceeds to T382. T382 is the same as T234 in FIG. 9.

When the YES button A2 on the re-prompt screen SC6 is selected in T384, the terminal device 6 proceeds to T386. T386 to T398 are the same as T352 to T364 in FIG. 10. In the present case also, the user can be reminded of subscribing to the subscription service, by which user convenience can be improved. Here, a situation in which the login session with the SP server 2 is not established (i.e., not present) when the YES button A2 is selected in T384 can be assumed. In this situation, the terminal device 6 may execute the processes of T12 to T16 in FIG. 6 by using the account information AC1 stored in T376.

Also, a case in which the NO button A3 on the re-prompt screen SC6 is selected and a case in which the NO button A6 on the keeping confirmation screen SC4 displayed in T372 is selected can be assumed. In these cases, the terminal device 6 discards the information collected through T322 to T332 in FIG. 10.

### Correspondence Relations

T352 to T364 are an example of “subscription process”.

### Fifth Embodiment

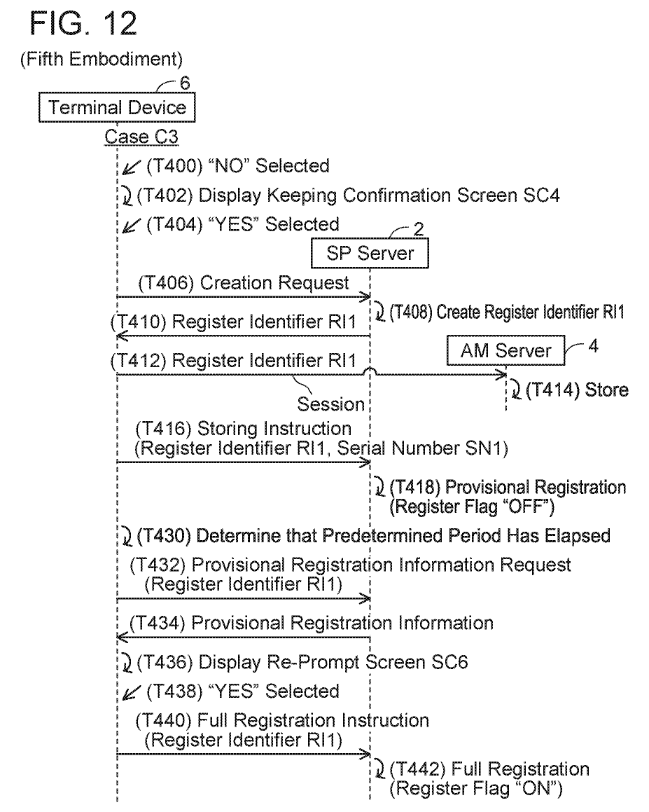

The present embodiment has the same configuration as the fourth embodiment except that the SP server 2 has the function of provisional registration and the contents of the processes executed when the NO button A3 is selected are different. FIG. 12 indicates Case C3 in which the NO button A3 on the prompt screen SC2 is selected in T342.

### Case C3; FIG. 12

T400 to T404 are the same as T370 to T374 in FIG. 11. When the YES button A5 on the keeping confirmation screen SC4 is selected, the terminal device 6 executes processes of T406 to T418. If the NO button A6 on the keeping confirmation screen SC4 is selected, the processes of T406 and thereafter to be described alter are skipped, and the processes of FIG. 12 end.

T406 to T418 are the same as T40 to T52 in FIG. 6. That is, in the present embodiment, when the user’s approval is not obtained in the prompt screen SC2, the information for subscribing to the subscription service is stored in the provisional registration in the SP server 2.

In T430, the terminal device 6 determines whether a predetermined time has elapsed since the date and time when the information for subscribing to the subscription service was stored in the provisional registration. If it is determined that the predetermined time has not elapsed since the date and time of the provisional registration, the terminal device 6 does not execute the processes of T432 and thereafter to be described later but repeats the determination of T430.

When the terminal device 6 determines that the predetermined time has elapsed since the date and time of the provisional registration, the terminal device 6 proceeds to T432. In T432, the terminal device 6 sends a provisional registration information request which requests the provisional registration information to the SP server 2. Due to this, the terminal device 6 receives the provisional registration information stored in association with the register identifier RI1 included in the provisional registration information request from the SP server 2 in T434. Then, the terminal device 6 displays the re-prompt screen SC6 on the display unit 66 by using the provisional registration information received in T434 in T436.

When the YES button A2 on the re-prompt screen SC6 is selected in T436, the terminal device 6 proceeds to T440. In T440, the terminal device 6 sends a full registration instruction which instructs to change to the full registration to the SP server 2.

When the SP server 2 receives the full registration from the terminal device 6 in T440, the SP server 2 proceeds to T442. In T442, the SP server 2 changes the registration flag stored in association with the register identifier RI1 included in the full registration instruction from “OFF” to “ON”. Due to this, the full registration is completed. In the present case also, the user can be reminded of subscribing to the subscription service, by which user convenience can be improved.

Also, the NO button A3 on the re-prompt screen SC6 is selected, the terminal device 6 sends a deletion instruction for the provisional registration to the SP server 2.

### Correspondence Relations

The storing instruction in T362 in FIG. 10 is an example of “second storing instruction”. The storing instruction of T416 in FIG. 12 is an example of “third storing instruction”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification 1

The “image processing device” is not limited to the printer 8, but may be a scanner, a multi-function peripheral, for example. The multi-function peripheral has plural functions including print function and scan function.

### Modification 2

The “device information” is not limited to the serial number SN1 but may be a MAC address of the printer 8, for example.

### Modification 3

In the first embodiment, the processes of T60 to T64 and the processes of T90 to T94 may not be executed. Also, in the second embodiment, the processes of T140 to T146 may not be executed. Also, in the third embodiment, the processes of T238 to T254 may not be executed. In these modifications, the “authentication information” is omitted. In these modifications, instead of displaying the PIN code, the full registration instruction same as T440 in the fifth embodiment may be sent to the SP server 2. In the present modification, the sending of the full registration instruction is an example of “subscription process”.

### Modification 4

In the fourth and fifth embodiments, as in the first to third embodiments, authentication using the PIN code may be executed.

### Modification 5

In each of the embodiments, the register identifier may not be used. In the present modification, the address information AD1 and the payment information PI1 collected from the AM server 4 themselves may be stored in the registration table 36. In the present modification, “specifying information” is omitted.

### Modification 6

The prompt screen SC2 may not include at least one of the selection object A1 and

the EDIT button A4. In the present modification, at least one of “object for editing the subscription information” and “object for adding information other than the subscription information” is omitted.

### Modification 7

In each of the above embodiments, the respective processes of FIGS. 6 to 12 are realized by the respective CPU executing the corresponding program. Instead of these, any of the processes may be realized by hardware such as a logic circuitry.

What is claimed is:

1. A non-transitory computer-readable recording medium storing computer-readable instructions for a terminal device, wherein the computer-readable instructions, when executed by a processor of the terminal device, cause the terminal device to:
in a case where a predetermined instruction is inputted, start a setup process for setup of an image processing device being different from the terminal device;
during a period from when the setup process starts until when the setup process ends, collect subscription information for subscribing to a service for the image processing device, wherein the subscription information includes user information related to a user of the image processing device and device information related to the image processing device;
in a case where the setup process ends, display a prompt screen on a display unit of the terminal device, wherein the prompt screen is for displaying at least the user information of the collected subscription information and prompting to subscribe to the service by using the subscription information, and the prompt screen includes a first object for receiving the user’s approval; and
in a case where the first object included in the prompt screen is selected, execute a subscription process for subscribing to the service.

2. The non-transitory computer-readable recording medium according to claim 1, wherein
the computer-readable instructions, when executed by the processor, further cause the terminal device to:
during the period from when the setup process starts until when the setup process ends, send a first storing instruction to a server which provides the service, the first storing instruction being for causing the server to store the device information in association with the user information, and
the subscription process is for changing a state of the device information stored in the server from a fist state where the server does not permit provision of the service which uses the device information to a second state where the server permits provision of the service which uses the device information.

3. The non-transitory computer-readable recording medium according to claim 2, wherein the subscription process includes a process for displaying, on the display unit, authentication information for the server which provides the service to authenticate the image processing device,
the authentication information is inputted to the image processing device and is sent from the image processing device to the server, and
the server changes the state of the device information from the first state to the second state in response to successful authentication of the authentication information received from the image processing device.

4. The non-transitory computer-readable recording medium according to claim 2, wherein the subscription information is collected by receiving the user information from a management device configured to manage the user information, and
the first storing instruction is an instruction for causing the server to store the device information in association with specifying information for specifying the user information managed at the management device.

5. The non-transitory computer-readable recording medium according to claim 2, wherein the computer-readable instructions, when executed by the processor, further cause the terminal device to:
in a case where the first object included in the prompt screen is not selected and the user’s approval is not received, send a deleting instruction that instructs deletion of the device information in the server to the server.

6. The non-transitory computer-readable recording medium according to claim 2, wherein the computer-readable instructions, when executed by the processor, further cause the terminal device to:
in a case where the first object included in the prompt screen is not selected and the user’s approval is not received, display a confirmation screen on the display unit, wherein the confirmation screen is for confirming whether the device information is to be kept in the first state in the server and the confirmation screen includes a second object for receiving the user’s approval,
in a case where the second object included in the confirmation screen is selected, the device information is kept in the first state in the server, and
in a case where the second object included in the confirmation screen is not selected and the user’s approval is not received, the device information is deleted from the server.

7. The non-transitory computer-readable recording medium according to claim 6, wherein the computer-readable instructions, when executed by the processor, further cause the terminal device to:
after the device information has been kept in the first state in the server, display the prompt screen on the display unit again by using the device information kept in the server.

8. The non-transitory computer-readable recording medium according to claim 1, wherein the subscription process includes a process for sending a second storing instruction to a server which provides the service, the second storing instruction being for causing the server to store the device information in association with the user information.

9. The non-transitory computer-readable recording medium according to claim 8, wherein the computer-readable instructions, when executed by the processor, further cause the terminal device to:
in a case where the user’s approval is not received in the prompt screen, store the subscription information in the terminal device; and
after the subscription information has been stored in the terminal device, display the prompt screen on the display unit again by using the subscription information stored in the terminal device.

10. The non-transitory computer-readable recording medium according to claim 8, wherein the subscription process includes a process for sending the second storing instruction for causing the server which provides the service to store the device information in a second state in association with the user information to the server,
the second state is a state where the server permits provision of the service which uses the device information, and
the computer-readable instructions, when executed by the processor, further cause the terminal device to:
in a case where the first object included in the prompt screen is not selected and the user’s approval is not received, send the server a third storing instruction for causing the server to store the device information in a first state in association with the user information, wherein the first state is a state where the server does not permit provision of the service which uses the device information; and
after the device information has been stored in the first state in association with the user information, display the prompt screen on the display unit again by using the device information stored in the server in the first state.

11. The non-transitory computer-readable recording medium according to claim 1, wherein the prompt screen includes at least one of: an object for editing the subscription information and an object for adding information other than the subscription information.

12. The non-transitory computer-readable recording medium according to claim 1, wherein the user information includes payment information for the user to pay a fee for the service.

13. The non-transitory computer-readable recording medium according to claim 1, wherein the device information includes identification information for identifying the image processing device.

14. The non-transitory computer-readable recording medium according to claim 1, wherein the image processing device has a print function, and
the setup process includes a process for displaying a specific screen on the display unit, wherein the specific screen is for prompting an initial setting of the print function.

15. A server comprising:
a memory; and
a controller configured to:
during a period from when a terminal device starts a setup process for setup of an image processing device being different from the terminal device until the terminal device ends the setup process, receive a storing instruction from the terminal device, wherein the terminal device collects subscription information for subscribing to a service for the image processing device during the period from when the terminal device starts the setup process until the terminal device ends the setup process, the subscription information includes user information related to a user of the image processing device and device information related to the image processing device, wherein after the setup process has ended, the terminal device displays a first prompt screen on the terminal device and the first prompt screen is a screen for displaying at least the user information of the collected subscription information and prompting to subscribe to the service by using the subscription information, wherein the storing instruction is an instruction for causing the server to store the device information in the memory in association with the user information;
in a case where the storing instruction is received from the terminal device, store the device information in a first state in the memory in association with the user information, wherein the first state is a state where the server does not permit provision of the service which uses the device information; and
in a case where the terminal device receives the user’s approval for subscription to the service in the first prompt screen, change a state of the device information in the memory from the first state to a second state where the server permits provision of the service which uses the device information.

16. The server according to claim 15, wherein in a case where the user’s approval is not received in the first prompt screen, the device information is kept in the first state in the memory,
the controller is further configured to:
after the device information has been kept in the first state in the memory, send the terminal device a display instruction for causing the terminal device to display a second prompt screen, wherein the second prompt screen is a screen for displaying the user information stored in the memory in association with the device information kept in the first state in the memory and prompting to subscribe to the service.

17. The server according to claim 15, wherein in a case where the user’s approval is not received in the first prompt screen, the device information is kept in the memory in the first state, and
the controller is further configured to:
after the device information has been kept in the first state in the memory, send the image processing device a display instruction for causing the image processing device to display a third prompt screen, wherein the third prompt screen is a screen for displaying the user information stored in association with the device information kept in the first state in the memory and prompting to subscribe to the service.

18. The server according to claim 15, wherein the prompt screen includes at least one of: an object for editing the subscription information and an object for adding information other than the subscription information.

19. The server according to claim 15, wherein the user information includes payment information for the user to pay a fee for the service.

20. The server according to claim 15, wherein the device information includes identification information for identifying the image processing device.

21. The server according to claim 15, wherein the image processing device has a print function, and
the setup process includes a process for displaying a specific screen on the terminal device, wherein the specific screen is for prompting an initial setting of the print function.

22. A non-transitory computer-readable recording medium storing computer-readable instructions for a terminal device, wherein the computer-readable instructions, when executed by a processor of the terminal device, cause the terminal device to:
in a case where a predetermined instruction is inputted, send, to an image processing device different from the terminal device, a request so as to receive device information related to the image processing device from the image processing device as information for subscribing to a service for the image processing device;
in the case where the predetermined instruction is inputted, send, to a management device which manages user information related to a user of the image processing device, a request so as to receive the user information from the management device as information for subscribing to the service for the image processing device;
in a case where the device information is received from the image processing device and the user information is received from the management device, display a prompt screen on a display unit of the terminal device, wherein the prompt screen is for displaying at least the user information among the device information and the user information and prompting to subscribe to the service by using the device information and the user information, and the prompt screen includes an object for receiving the user’s approval; and
in a case where the object included in the prompt screen is selected, execute a subscription process for subscribing to the service.

23. A communication system comprising:
a terminal device;
an image processing device configured to communicate with the terminal device; and
a management device configured to communicate with the terminal device and manage user information related to a user of the image processing device,
wherein the terminal device is configured to:
in a case where a predetermined instruction is inputted, send the image processing device a first request for requesting device information related to the image processing device; and
in the case where the predetermined instruction is inputted, send the management device a second request for requesting the user information,
wherein the image processing device is configured to send the terminal device the device information according to the first request, and
the management device is configured to send the terminal device the user information according to the second request,
wherein the terminal device is further configured to:
in a case where the device information is received from the image processing device and the user information is received from the management device, display a prompt screen on a display unit of the terminal device, wherein the prompt screen is for displaying at least the user information among the device information and the user information and prompting to subscribe to the service by using the device information and the user information, and the prompt screen includes an object for receiving the user’s approval; and
in a case where the object included in the prompt screen is selected, execute a subscription process for subscribing to the service.
